(19) United States
(12) Patent Application Publication
(10) Pub. No.: US 2003/0187722 A1
(43) Pub. Date: Oct. 2, 2003

(54) Method of supporting product life cycle planning and apparatus for executing the same

(76) Inventor: Hideki Kobayashi, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/392,865

(22) Filed: Mar. 21, 2003

(30) Foreign Application Priority Data
Mar. 29, 2002 (JP) 2002-097910
Jan. 14, 2003 (JP) 2003-005985

(51) Int. Cl. G06F 17/60

(52) U.S. Cl. 705/10

(57) ABSTRACT

A method of supporting a product life cycle planning comprises drawing up a quality function deployment matrix and an environment specification matrix according to environment specification taking account of quality specification and environmental load which are based on quality function deployment, outputting one of the quality function deployment matrix and the environment specification matrix and a particular specification item of the other, and determining harmony between the quality specification and the environment specification based on the quality function deployment matrix and the environment specification matrix.

### CROSS-REFERENCE TO RELATED APPLICATIONS

This application is based upon and claims the benefit of priority from the prior Japanese Patent Applications No. 2002-097910, filed Mar. 29, 2002; and No. 2003-005985, filed Jan. 14, 2003, the entire contents of both of which are incorporated herein by reference.

### BACKGROUND OF THE INVENTION

1. Field of the Invention

The present invention relates to a product life cycle planning support method of supporting project and conceptual design of an environmentally conscious product and an apparatus executing the same.

2. Description of the Related Art

There is a quality function deployment (QFD) as a technique to make a customer satisfaction degree of a product improve. QFD can set a target value of product property based on customer demands (QFD-I), and specifies important parts property for a customer (QFD-II), so that it can plan a product of a high customer satisfaction degree.

Items such as energy consumptions existing in both of the target specification of a product quality aspect and target specification of an environmental aspect are set to target specifications contradicted to each other in order to meet a customer demand and an environment demand respectively. Such an inconsistency (trade-off) has to be settled as soon as possible.

Because QFD is not to consider the environmental aspect of a product, it has been executed by devising compromise plan to settle the inconsistency after setting quality specification based on the QFD and environment specification based on some measure.

Further, when a solution to realize an environmentally conscious product is derived, a method of considering a market competitive power of a product has not existed. For this reason, the solution to construct concept of the environmentally conscious product may not always provide a product including charm for a customer, or provide an unbearable product for a customer.

It is an object of the present invention to provide a product life cycle planning support method and apparatus to promote compromise of target specification with respect to quality items repeating at quality aspect and environmental aspect.

### BRIEF SUMMARY OF THE INVENTION

According to a first aspect of the invention, there is provided a method of supporting a product life cycle planning comprising: drawing up a quality function deployment matrix and an environment specification matrix according to a quality specification and an environment specification, respectively, wherein both the quality specification and the environmental load are based on the quality function deployment; outputting one of the quality function deployment matrix and the environment specification matrix and a specification item of the other of the quality function deployment matrix and the environment specification matrix; and determining harmony between the quality specification and the environment specification by adjusting, on the quality function deployment matrix and the environment specification matrix, a value of a property item of at least one of the quality specification and the environment specification.

According to a second aspect of the invention, there is provided a apparatus supporting a product life cycle planning comprising: a matrix drawing unit configured to draw up a quality function deployment matrix and an environment specification matrix according to a quality specification and an environment specification, respectively, wherein both the quality specification and the environmental load are based on the quality function deployment; an output unit configured to output one of the quality function deployment matrix and the environment specification matrix and a specification item of the other of the quality function deployment matrix and the environment specification matrix; and a determination unit configured to determine harmony between the quality specification and the environment specification by adjusting, on the quality function deployment matrix and the environment specification matrix, a value of a property item of at least one of the quality specification and the environment specification.

### BRIEF DESCRIPTION OF THE SEVERAL VIEWS OF THE DRAWING

FIG. 1 shows a block diagram of a product life cycle planning support apparatus according to an embodiment of the present invention.

FIG. 2 shows a diagram for explaining a product life cycle planning support operation carried out by the product life cycle planning support apparatus of FIG. 1.

FIG. 3 shows a flowchart explaining a target specification configuration procedure of FIG. 2.

FIG. 4 shows QFD-I matrix.

FIGS. 5A to 5C show an environment specification matrix.

FIGS. 6A to 6C show an example of a pop up display.

FIG. 7 shows another example of a pop up display.

FIG. 8 shows a flowchart for explaining a detection method of repetition property.

FIG. 9 shows a flowchart for explaining an inconsistency conquest support procedure.

FIG. 10 shows an inconsistency discovery table.

FIG. 11 shows an example of a property name described by the inconsistency conquest table according to TRIZ.

FIG. 12 shows another inconsistency conquest table.

FIG. 13 is a diagram for explaining an inconsistency conquest principle.

FIG. 14 shows an upgrade analysis procedure.

FIG. 15 shows an example of value degradation affect analysis.

FIG. 16 shows QFD-II.

FIG. 17 shows an upgrade analysis chart.

FIG. 18 shows a maintenance analysis procedure.

FIG. 19 shows a maintenance analysis chart.

FIG. 20 shows a reuse analysis procedure.

FIG. 21 shows a reuse analysis chart.

### DETAILED DESCRIPTION OF THE INVENTION

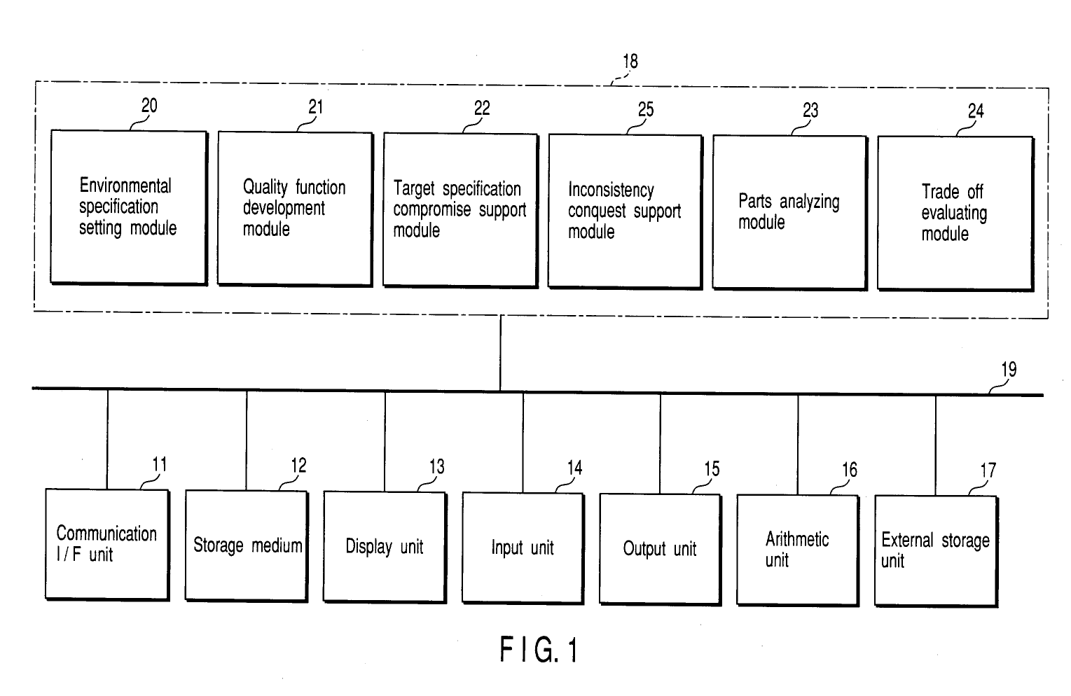

FIG. 1 shows a configuration of a product life cycle planning support apparatus according to the present invention. According to this configuration, a communication I/F unit 11, a recording medium driver 12, a display unit 13, an input unit 14, an output unit 15, an arithmetic unit 16, an external storage unit 17, and a memory 18 are connected via a bus 19.

A program regarding various measures of the product life cycle planning support apparatus of the embodiment of the present invention is stored in the external storage unit 17. The product life cycle planning support apparatus operates when a program regarding an environment specification setting module 20, a quality function deployment module 21, a target specification compromise support module 22, an inconsistency conquest support module 25, a parts analyzing module 23 and a trade-off evaluating module 24 is read into the memory 18 at need. A database such as a life cycle planning (LCP) database that stores various information generated in the life cycle planning and a life cycle planning result is saved in an external storage unit 17.

The arithmetic unit 16 performs input/output control or various arithmetic processing by executing the program in the memory 18. A mouse and a keyboard are used as the input device 14, a printer as the output unit 15, and a CRT display or a liquid crystal display as the display unit 13. The recording medium driver 12 comprises a floppy disk drive, an optical disk drive, and the like.

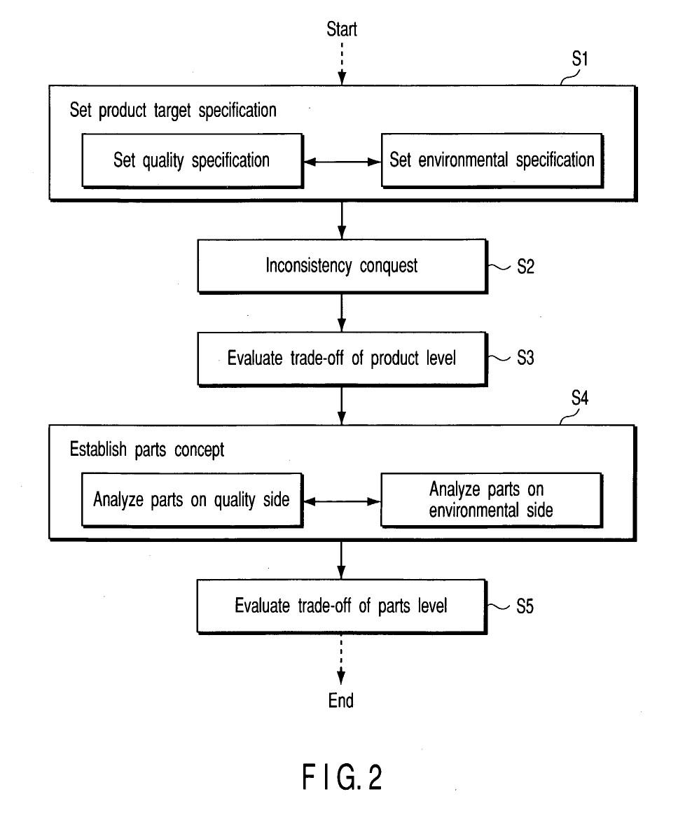

There will now be described an operation of the product life cycle planning support apparatus of the embodiment with reference to FIG. 2. This operation is executed by a computer including the arithmetic unit 16 according to the program transferred to the memory 18 from the external storage unit 17. The process result is displayed on the display unit 13.

In the present embodiment, setting of the target specification of a product level and various analysis of a parts level are based, and there are five steps as shown in FIG. 2. These steps are as follows:

1. Setting of Product Target Specification

The target specification of a product level is set. The specification of the quality aspect is set using a QFD-I matrix. Further, the specification of the environmental aspect is set using a dedicated environment specification matrix. Concept of the product level which satisfies these target specifications is established. In this process, it is an important problem to set an appropriate target value that does not contradict with respect to overlapping property between the quality aspect and the environmental aspect. In the embodiment of the present invention, this problem will be solved by a method described later.

2. Inconsistency Conquest

Since negative correlation is between two evaluation characteristic items in the target specification, there is a case that innovative product concept for achieving the target values with regard to both characteristic items simultaneously comes to need. The present invention supports to create an idea for conquering inconsistency effectively by providing a module which accesses existing innovative idea support information automatically.

3. Trade-Off Evaluation of Product Level

The formulated concept of a product level is comprehensively evaluated based on a quality aspect, an environment aspect and a cost aspect, and absence of trade-off in each aspect is confirmed to determine adoption of the concept. Whether this concept should be adapted from a general standpoint is determined by evaluating, for example, a case where a big harmful effect occurs with respect to the quality aspect even if the concept has effect with respect to the environmental aspect. In addition, this step may be omitted in a case of improvement design of an existing product.

4. Analysis of Parts Level and Formulation of Parts Concept

Various analyses of parts level are performed to derive a solution for realizing a target specification. Then, the solution of the quality aspect is derived using a QFD-II matrix. Further, the solution of the environmental aspect is derived using various life cycle option analysis charts as described later.

5. Trade-Off Evaluation of Parts Level

With respect to the derived solution, the tradeoff is evaluated to decide solution to be adopted.

As a result, the target specification (quality aspect and environmental aspect) of a design target product and the concept of an environmentally conscious product for implementation of the target specification are settled to the level of parts.

The above operation will be described in detail using a notebook personal computer as an example.

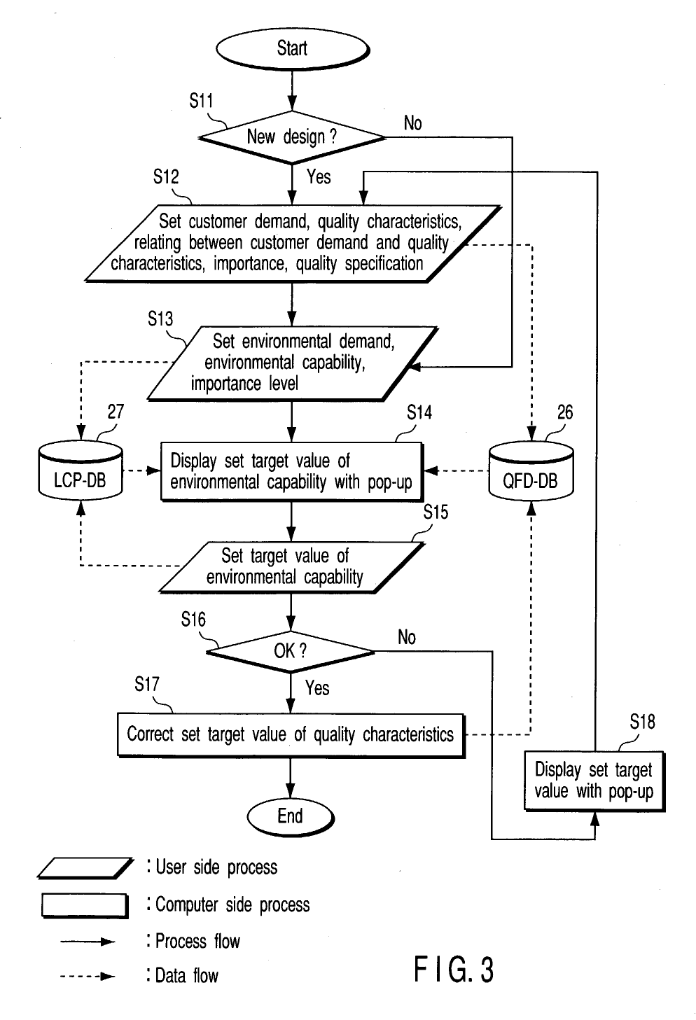

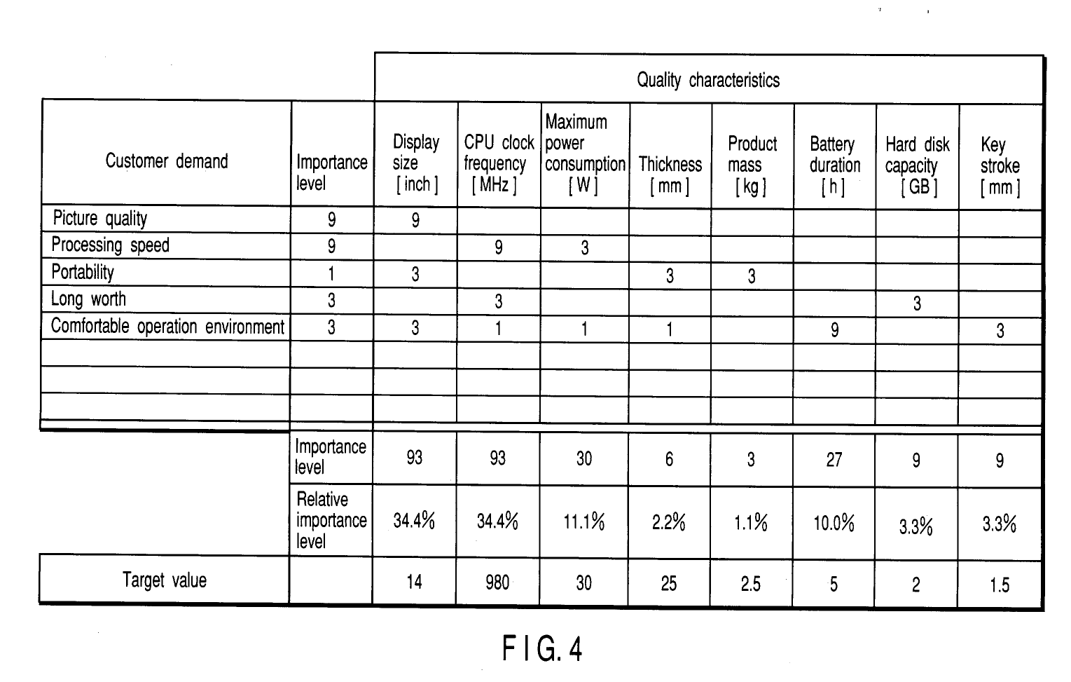

FIG. 3 shows a target specification setting procedure. At first a planning and designing person determines whether a target product is newly designed or whether it is an improvement design of an existing product (S11). A customer demand, quality characteristics, a relationship between the customer demand and quality characteristics, importance of the quality characteristics, and quality specification are set using a QFD-I matrix as shown in FIG. 4 (S12).

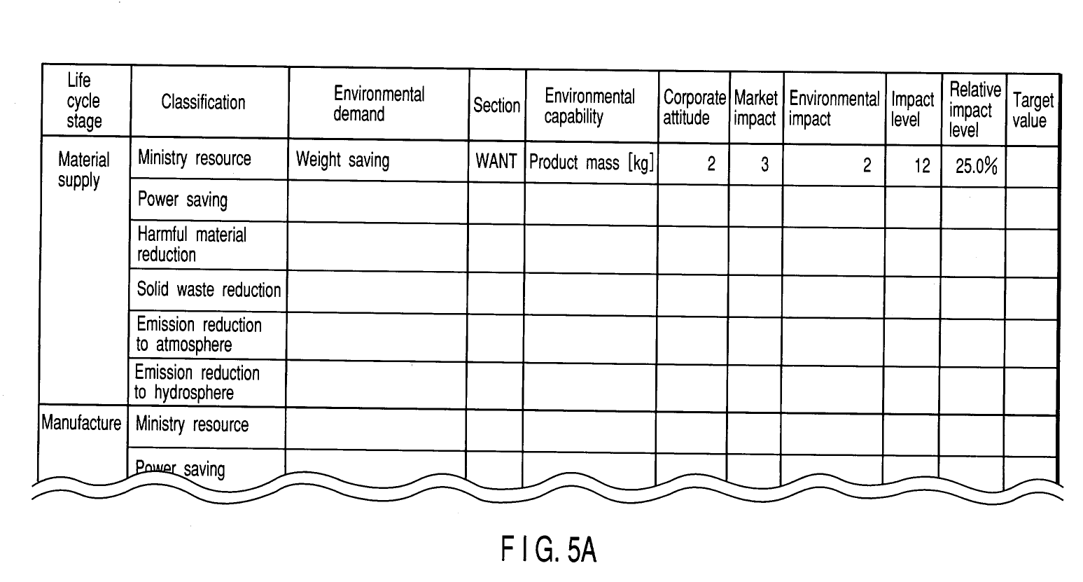

The planning and designing person sets an environment demand, environmental capability and a degree of influence of environmental capability, using environment specification matrix (S13). This degree of influence is represented by product of a company posture, a market impact and an environmental impact as shown in FIGS. 5A to 5C. The environment demand is sectionalized into MUST demand that must always cope with and WANT demand that had better cope with if possible. The former degree of influence is set only by the WANT demand.

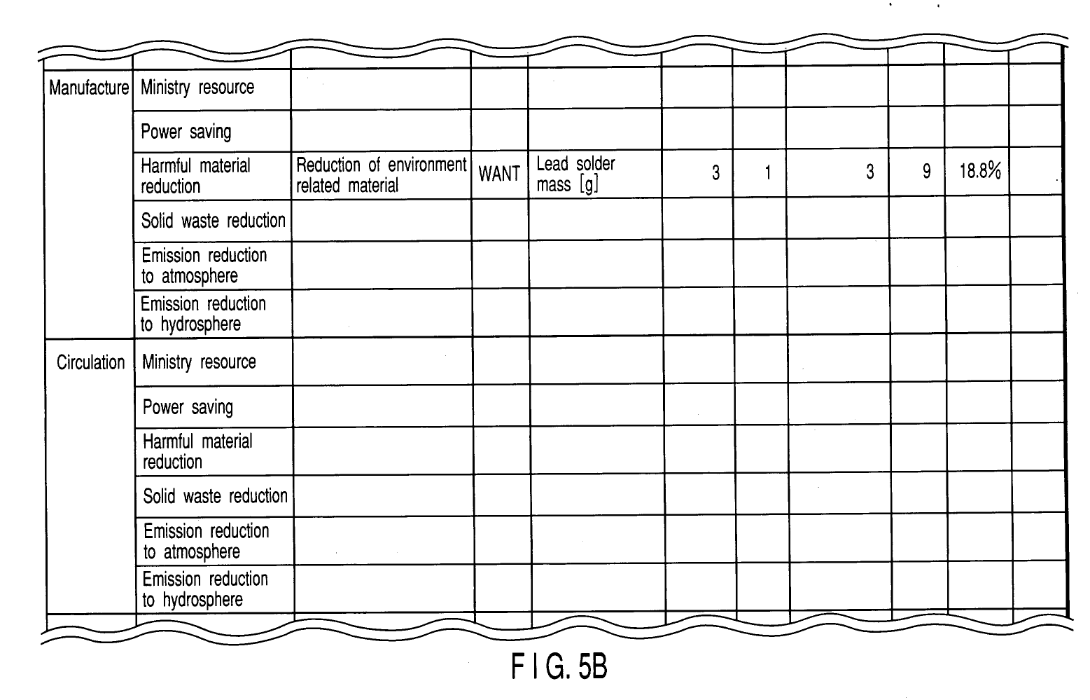

Furthermore, the planning and designing person sets a target value of environmental capability, that is, environment specification. In this instance, by putting a cursor on the cell of the target value of the environment specification matrix, for example, the system displays in pop-up a current target set value regarding the property that the quality characteristics and environmental capability are duplicated, as shown in FIG. 6C (S14). Thus, the target value can be set to a proper level (S15). In this embodiment, since the property of power consumption exists in both of the quality characteristics and the environmental capability, the system can set a target value of the power consumption that satisfy the customer demand and environment demand simultaneously by displaying set circumstance of the target value.

FIG. 6C show that the planning and designing person sets mean power consumption to 20W in consideration of the set value of maximum power consumption of 30W that is set using the QFD-I matrix. The target specification compromise support module 22 detects automatically similarity between characteristic items such as “the maximum power consumption” and “mean power consumption”, and makes the result display in pop-up. The detection of the characteristic items can be realized by combining an existing natural language processing technique with an inference processing technique.

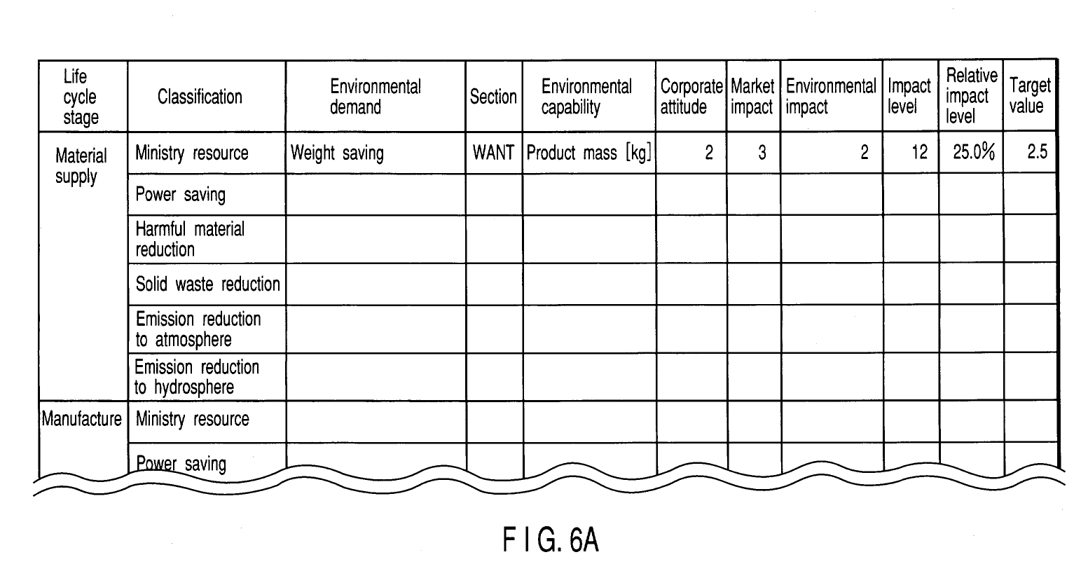

The operation of step S14 will be described as follows (FIG. 8). At first, property name data is read from QFD-DB (QFD database) 26 and LCP-DB (LCP database) 27 (S21). The delimiter of the words constructing the read property name and the kind of the part of speech of the word are specified by the morphological analysis (S22). Synonyms, synonyms, related words are searched from the divided words (S23). At last, a plurality of property names resembling conceptually are formed by combining the searched words (S24), and mean similarity between the property names is computed (S25). For example, when the “mean power consumption” is subjected to the morphological analysis, it is divided into three words “mean (noun)”, “consumption (noun)” and “power (noun)”. When the synonyms, synonyms and related words are searched with respect to these three words, “balance, stable”, “activity” and “electric force” are found.

In other words, the eleven words of “mean activity power”, “mean activity electric force”, “mean consumption electric force”, “balance power consumption”, “balance activity power”, “balance activity electric force”, “balance consumption electric force”, “stable power consumption”, “stable activity power”, “stable activity electric force” and “stable consumption electric force” are formed as a property name similar conceptually to the word “mean power consumption”. The property names that are conceptually similar to each other are generated about all characteristic items.

The similarity between the formed property names is computed by (the number of parts of speech to match)/(the number of mean parts of speech). In the case of “maximum power consumption” and “mean power consumption”, for example, the word “maximum power consumption” is divided into “maximum”, “consumption” and “power”, and the word “mean power consumption” into “mean”, “consumption” and “power”. In other words, the number of parts of speech is two, that is, “consumption” and “power”. Further, the number of mean parts of speech is (3+3)/2=3. Therefore, the similarity between “maximum power consumption” and “mean power consumption” is computed as ⅔=0.67. Such computation is performed about all combination of the property names generated. In the embodiment, the property names to be derived from “maximum power consumption” are 3*2*2=12. Similarly, the property names to be derived from “mean power consumption” are 2*2*2=8. Therefore, the similarity is computed with respect to the property names of 12*8=96. The mean value of the computed similarities is calculated. A group of property names that the mean similarity is larger than a threshold is detected as a repetition property.

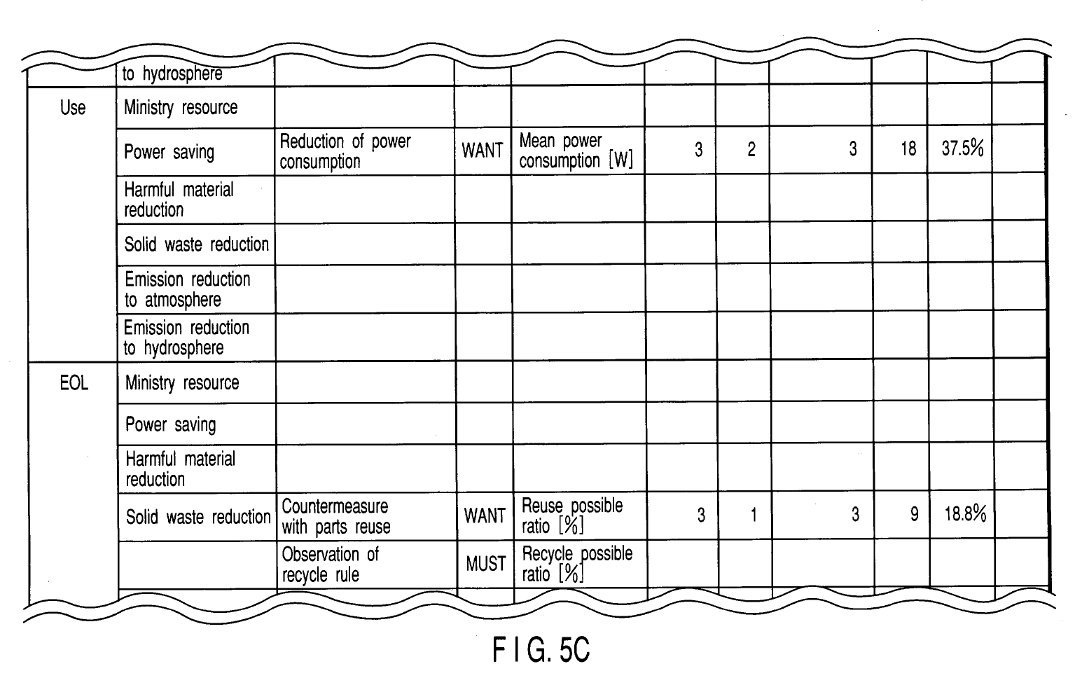

Based on the above result, whether the set target specification (quality specification and environment specification) is permitted is determined (S16). If it is permitted, the system corrects automatically the target value of power consumption of QFD-I matrix at need (S17), and terminates this step. If it is not permitted, the system returns to the QFD-I matrix again via a pop-up display (S18), and re-executes from setting the target value of the quality characteristics. In other words, the target value setting circumstance in the environment specification setting matrix is displayed in pop-up on the target value setting portion of the QFD-I as shown in FIG. 7. The process returns to step S12.

In addition, when the item set to the MUST property in the environment specification setting matrix repeats in QFD-I, the target value of QFD-I is set forcibly to the target value of the environment specification. The planning and designing person establishes concept of a product level achieving the target specification and having an appeal power to a customer most, in view of the target specification. However, the person needs an idea for achieving the target values regarding two evaluation characteristic items simultaneously, when negative correlation exists between the evaluation characteristic items.

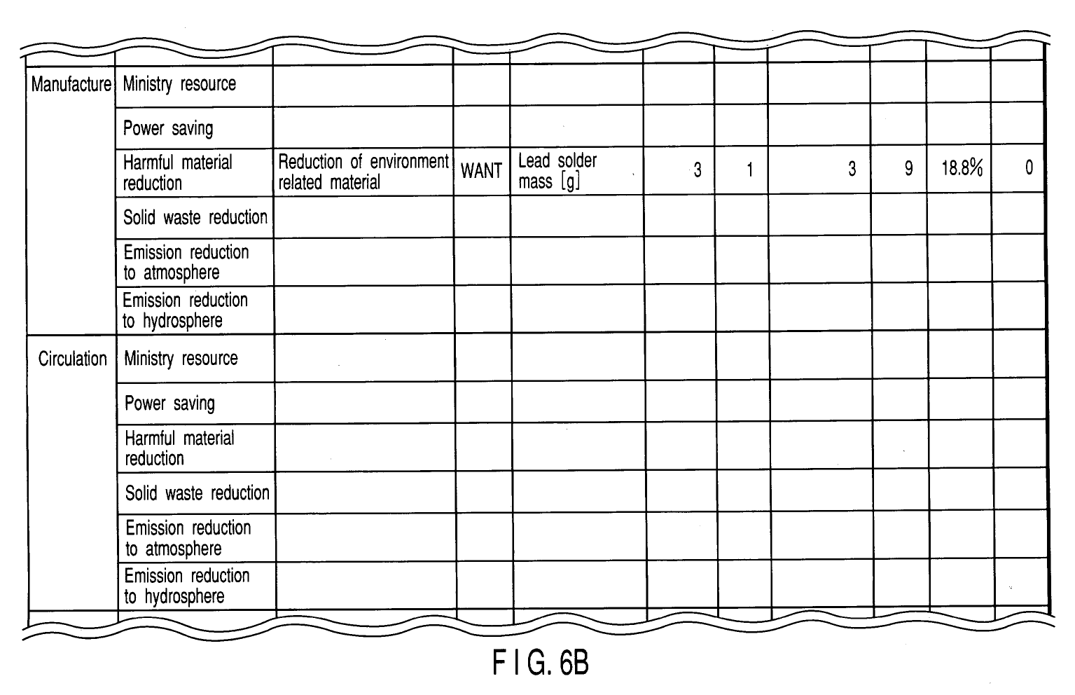

TRIZ (invention theory) is known as a technique for supporting an idea of innovative product concept. TRIZ is a technique consisting of a plurality of techniques, and often uses a table called particularly an inconsistency conquest table. A method of effectively utilizing the inconsistency conquest table in the product life cycle planning process will be described hereinafter (FIG. 9).

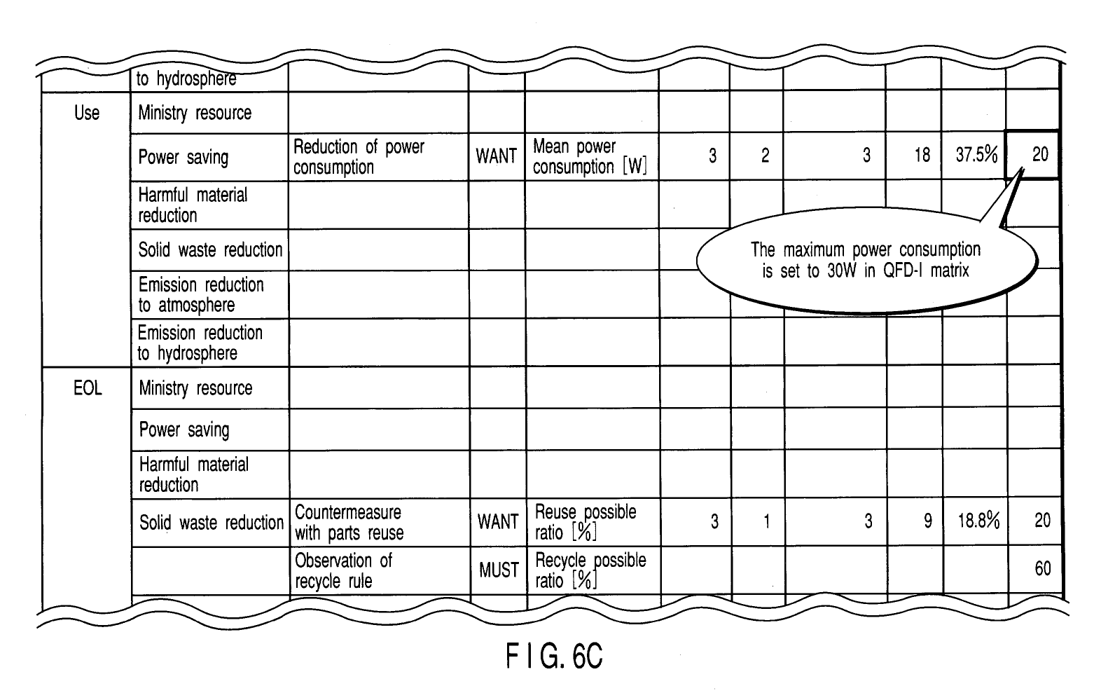

At first, names of the quality characteristics and environmental capability are read from QFD-DB26 and LCP-DB27 respectively to form automatically an inconsistency discovery table of a format of FIG. 10 (S31).

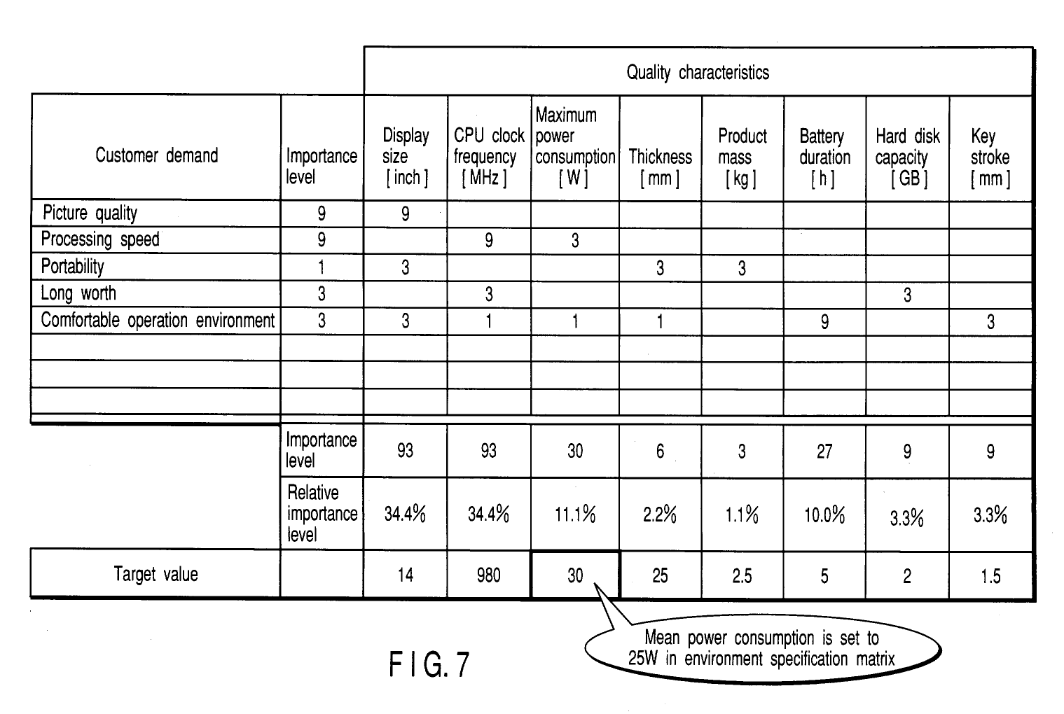

The names of the quality characteristics and environmental capability described in FIG. 10 are replaced with property names whose semantics are most near to those of the former names and which are ones of the property names described in the inconsistency conquest table of TRIZ (S32). The planning and designing person can access TRIZ information without being conscious of TRIZ by selecting a property name described in the inconsistency conquest table of TRIZ stored in TRIZ-DB (TRIZ database) 28 from a pull-down menu. FIG. 11 shows examples of property names described in the inconsistency conquest table of TRIZ.

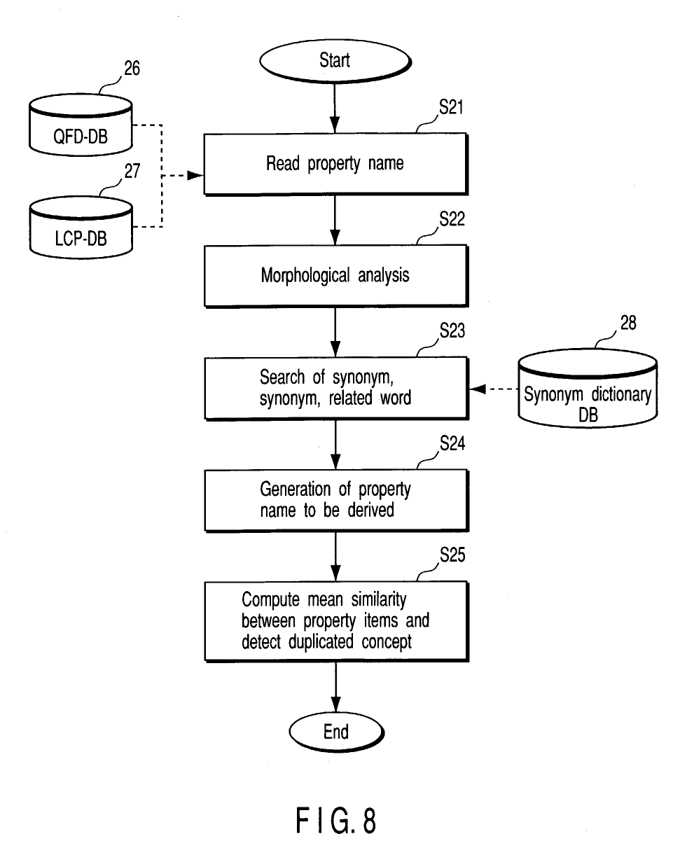

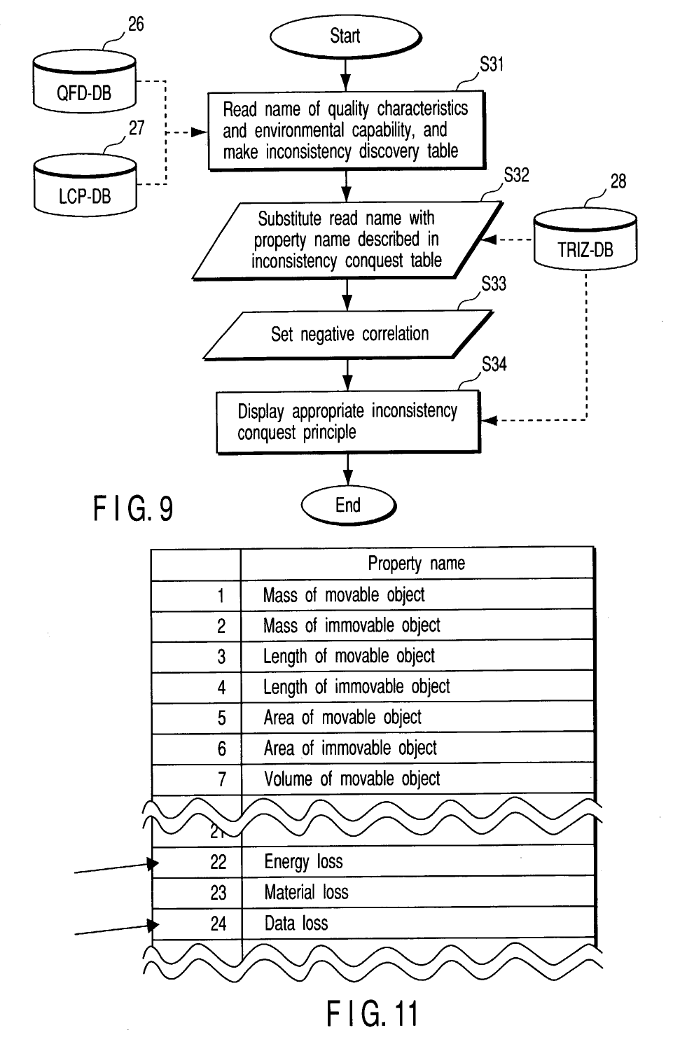

The planning and designing person sets negative correlation existing between the characteristic items of the quality characteristics and environmental capability as shown in FIG. 10 (S33). Note such negative correlation that power consumption increases and thus battery duration decreases when CPU clock frequency increases (FIG. 10). The CPU clock frequency is replaced with information loss (property number 24) of the property name of TRIZ aspect described in FIG. 11. Further, the battery duration is replaced with energy loss (property number 22). Then, the system accesses the inconsistency conquest table saved in TRIZ-DB in a format of FIG. 12 automatically, and provides principles 19 and 10 as principles for conquering inconsistency of property numbers 22 and 24. Thus, the system extracts an inconsistency conquest principle saved in TRIZ-DB automatically and provides it to the planning and designing person (S34). For example, the principle 19 is “a principle of periodic action” according to the FIG. 13. It is displayed as description such as “use of periodic action or pulse action, change of frequency, change of effect using pause between shocks”. The planning and designing person can get an idea from the above information, the idea including a method of nondecreasing a battery duration even if the CPU clock frequency is increased, for example, a concept such as a variable control of frequency or an intermittent operation of CPU. The concept of product level obtained by such idea is comprehensively evaluated from aspects of quality, environment and cost to determine appropriate concept of a proper product level.

There will now be described an up-grade analysis chart, a maintenance analysis chart and a reuse analysis chart as a serial life cycle option analysis chart for deriving a solution in parts level of the environmental aspect.

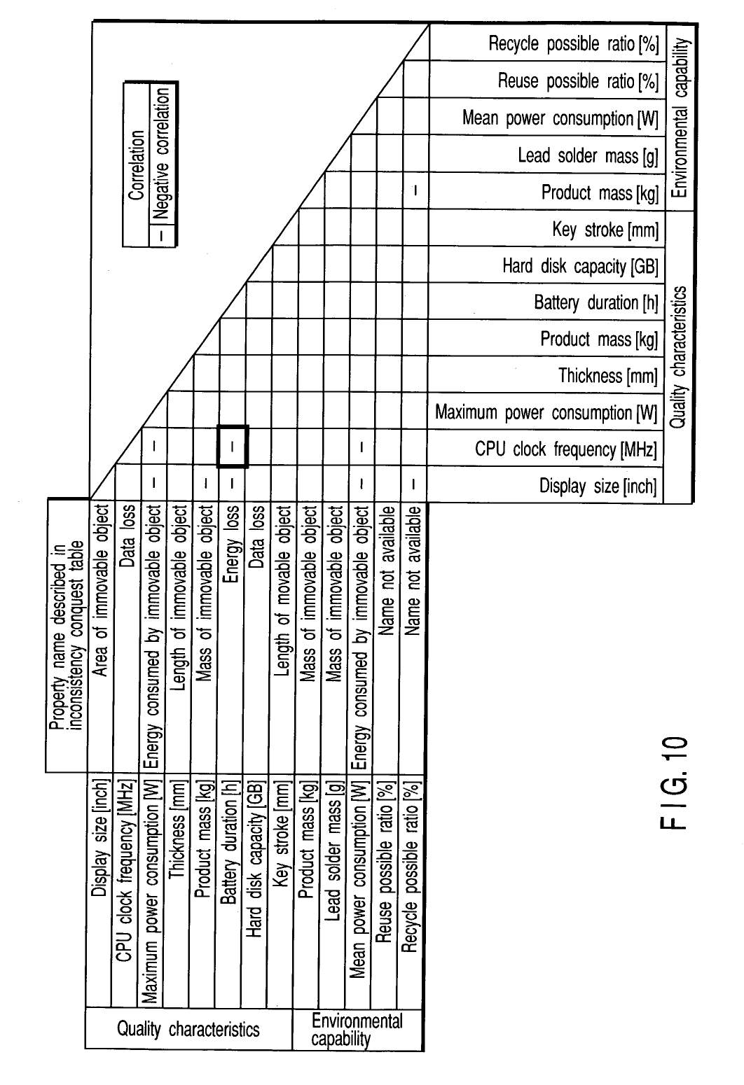

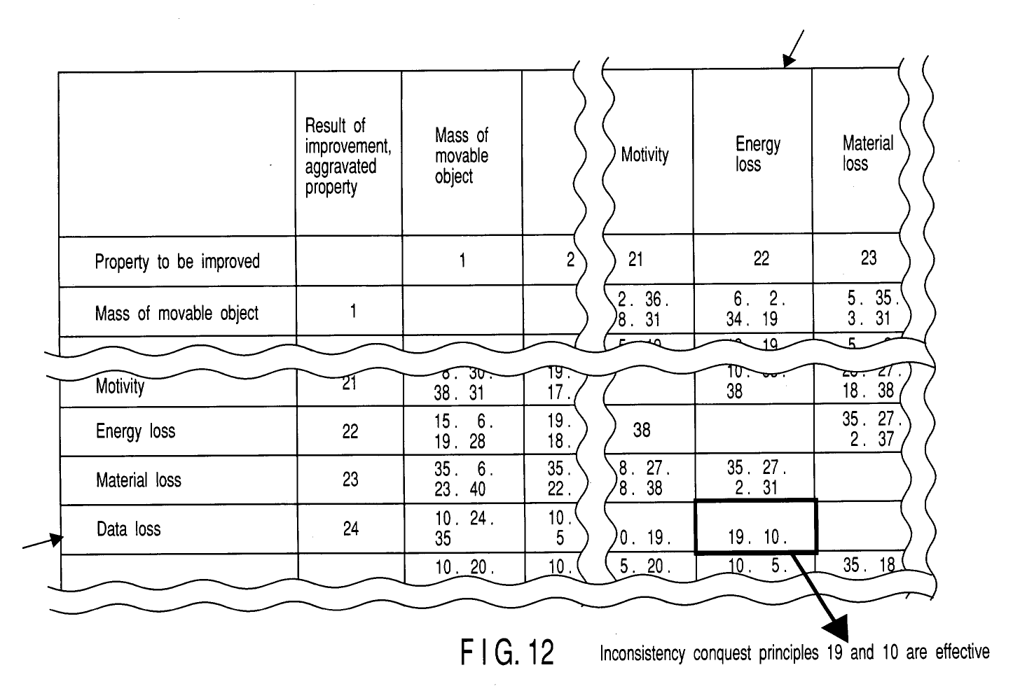

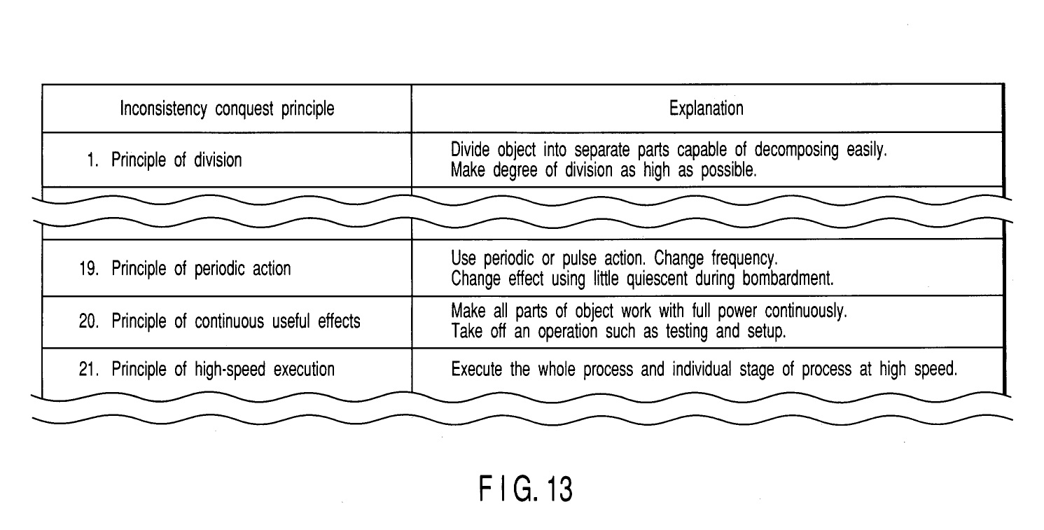

FIG. 14 shows an up-grade analysis procedure. According to this, at first, the planning and designing person inputs a degree of influence of a relative worth degradation of parts (S41). The degree of influence of the relative worth degradation is an index standardized that a part gives how much influence to a product to reduce the worth of the whole product (fashion nature, facility nature, etc.) so that the total value of all parts becomes 100%. FIG. 15 shows an analysis matrix for computing a degree of influence of relative worth degradation of parts. The relation between the quality characteristics and parts uses a result computed by the QFD-II matrix shown in FIG. 16. The degree of influence relative to factors making the worth of a notebook personal computer deteriorate is input, and the relation between those factors and the quality characteristics is input. As a result, the degree of influence of relative worth degradation of parts can be computed by a procedure similar to QFD.

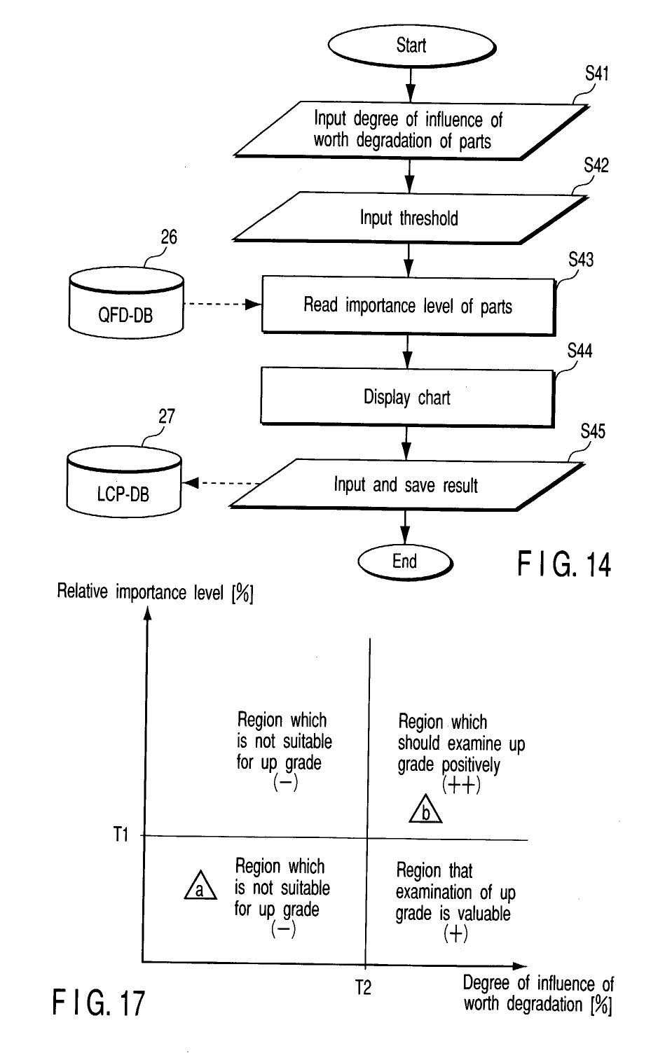

The planning and designing person sets a threshold regarding a relative importance and a degree of influence of relative worth degradation of parts (S42). The system reads the relative importance information of parts from the QFD database (S43), draws up a chart as shown in FIG. 17, and provides the planning and designing person with the chart (S44). In an example of FIG. 17, the chart is divided into four sections based on the threshold information, and the parts are mapped in them. This example illustrates that the parts a is not to be suitable for up grade, thus not to be subjected to up grade design, whereas the parts b should consider the up grade positively, thus to be subjected to the up grade design.

The planning and designing person determines every part whether the part should be subjected to the up grade design on the basis of the provided information, and inputs an idea capable of realizing the up grade design as a solution. Further, the person saves the solution in the LCP-DB (S45) and terminates the process.

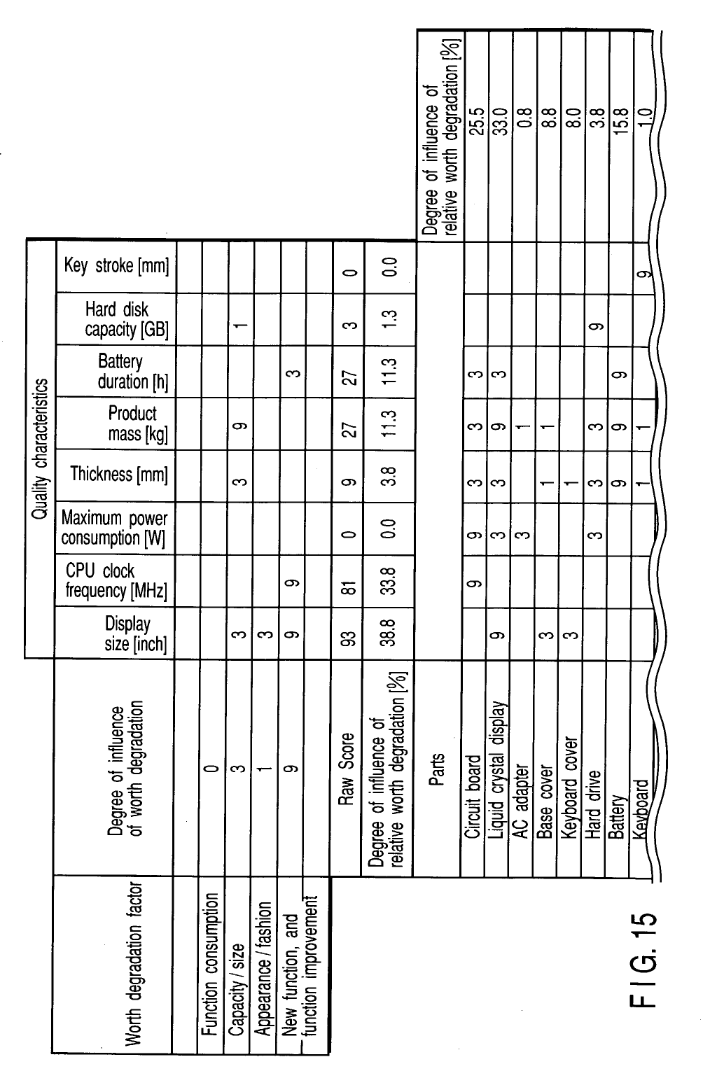

FIG. 18 shows a maintenance analysis procedure. According to this procedure, at first, the planning and designing person inputs a product useful life and a part useful life (S51). Then, the planning and designing person sets a threshold regarding a relative importance of parts to the system (S52). The relative importance level of parts is a result computed using the QFD-II matrix, and shows one example in FIG. 9.

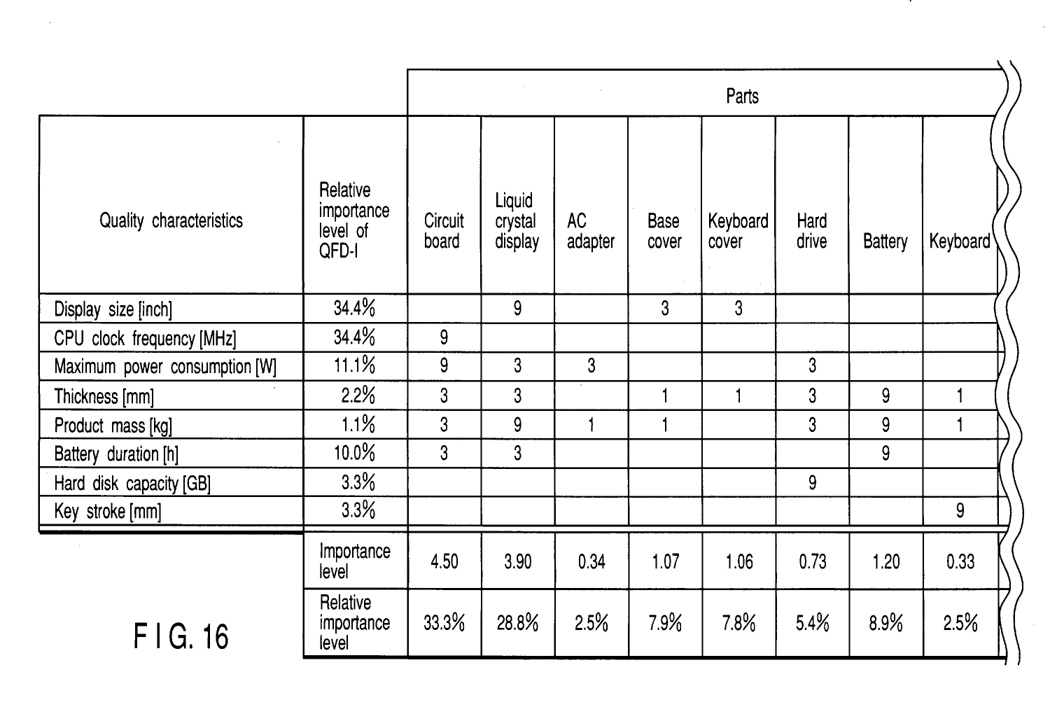

The system reads the relative importance information of parts from the QFD database (S53), and draws up a chart as shown in FIG. 19 and provides the planning and designing person with the chart (S54). In an example of FIG. 19, the chart is divided into a plurality of sections based on the threshold information preset. The parts are mapped in them. In this example, the threshold regarding the useful life is set equally to that of the product useful life. Here, the product usage period is also applicable for the threshold value. In this example, since the parts require a maintenance replacement, they are subjected to the maintenance design. In contrast, since the parts b hardly require the maintenance, the parts b are not subjected to the maintenance design. The planning and designing person determines every part whether the part should be subjected to the maintenance design on the basis of the provided information, and inputs an idea capable of realizing the maintenance design as a solution. The person saves the solution in the LCP-DB (S55) and terminates the process.

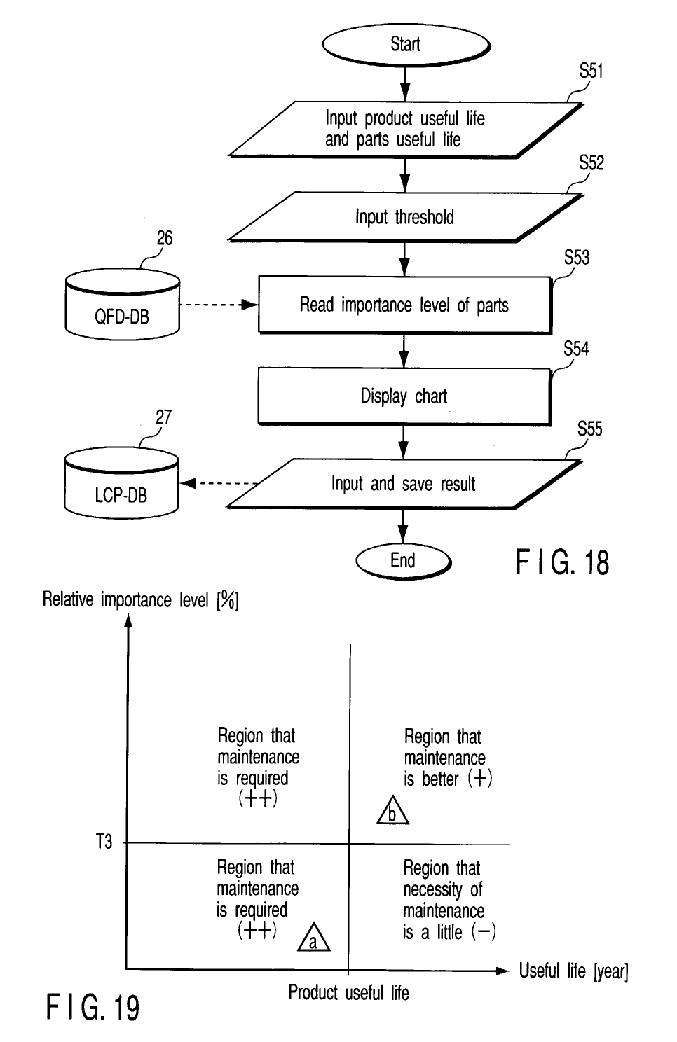

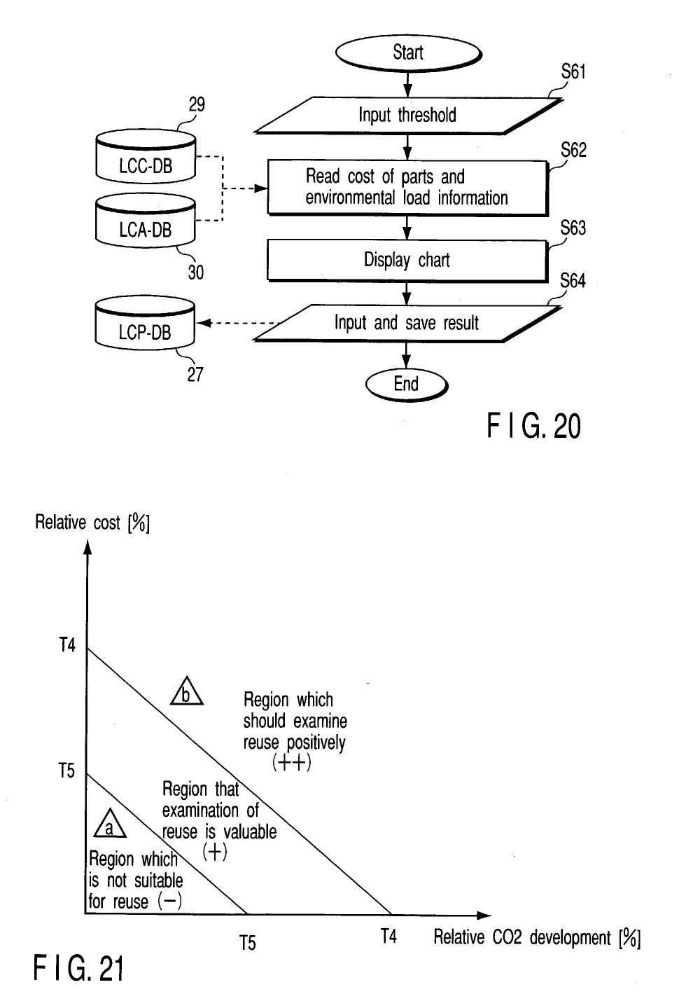

FIG. 20 shows a reuse analysis procedure. At first, the planning and designing person sets a threshold with regard to a relative cost and relative environment load of parts (S61). Then, the system reads the relative importance and relative environment load of parts from the life cycle cost (LCC: Life Cycle Costing) database (LCC-DB) 29 and the life cycle assessment (LCA: Life Cycle Assessment) database (LCADB) 30 (S42), draws up a chart as shown in FIG. 21, and provides the planning and designing person with the chart (S63). The relative cost means a ratio of a parts cost to the whole product cost. A relative CO₂ discharge is used as a representative example of the relative environment load. The relative CO₂ discharge means a ratio of the CO₂ discharge of specific parts to the CO₂ discharge of the whole product that occurs at stages of material supply and parts manufacture. The environmental load is not limited to CO₂ but may be set to an arbitrary environmental capability such as NOx and SOx. When the information to be read is not saved in the database, the planning and designing person may input approximate information.

In an example of FIG. 21, a chart is divided into a plurality of sections based on the threshold information preset. The parts are mapped in the sections. This example shows that the parts a is not suitable for reuse, and the parts b should be subjected to the reuse positively. In other words, it is suggested that the parts whose cost ratio and environmental load ratio are high had better perform the reuse positively. Here, it is possible to convert the value of 10% of relative CO₂ discharge into the cost rate using the Carbon Tax rate, and to line between the point of this cost rate on Y-axis and the point of 10% on X-axis.

The planning and designing person determines every part whether the part should be subjected to the reuse design on the basis of the provided information, and inputs an idea capable of realizing the reuse design as a solution. Further, the person saves the solution in the LCP-DB (S45) and terminates the process.

The concept of the parts level is formulated by combining the above-mentioned solutions. The planning and designing person again evaluates the concept of parts level from the aspects of quality, environment and cost, to determine a proper concept in the parts level. By the above procedure, the target specification and environmentally conscious product concept of a product are settled.

According to the present invention, the environmentally conscious product comprehensively considering the aspects of the quality, cost and environment can be projected and drawn up. By considering simultaneously items repeating with respect to the quality aspect and the environmental aspect, the environmentally conscious product which does not lose a market competitive power can be projected and drawn up.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of supporting a product life cycle planning comprising:
drawing up a quality function deployment matrix and an environment specification matrix according to a quality specification and an environment specification;
outputting one of the quality function deployment matrix and the environment specification matrix and a specification item of the other of the quality function deployment matrix and the environment specification matrix; and
determining harmony between the quality specification and the environment specification by adjusting, on the quality function deployment matrix and the environment specification matrix, a value of a property item of at least one of the quality specification and the environment specification.

2. The method according to claim 1, wherein the outputting comprises displaying the property item of the other of the quality specification matrix and the environment specification matrix with respect to the specification item that appears in both the quality specification and the environment specification.

3. The method according to claim 1, wherein the outputting comprises displaying a temporary target specification automatically to support compromise between a first target specification and a second target specification, when the first target specification and the second target specification include an identical property item or a property item having a correlation, the first target specification indicating a target specification of a quality aspect of a product included in the quality specification and the second target specification indicating a target specification of an environmental aspect included in the environment specification.

4. The method according to claim 1, which further comprises offering a solution to conquer inconsistency when the quality specification and the environment specification include contradictory corrective strategies.

5. The method according to claim 1, which the outputting further comprises displaying importance information of parts provided from the quality function deployment matrix and influence information of a degree of influence of worth degradation of the parts, the influence information representing an influence that the worth degradation of the parts exerts to a product disposal action of a consumer.

6. The method according to claim 1, which the outputting further comprises displaying importance information of parts provided from the quality function deployment and one of useful life information of the parts and reliability information of the parts.

7. An apparatus supporting a product life cycle planning comprising:
a matrix drawing unit configured to draw up a quality function deployment matrix and an environment specification matrix according to a quality specification and an environment specification;
an output unit configured to output one of the quality function deployment matrix and the environment specification matrix and a specification item of the other of the quality function deployment matrix and the environment specification matrix; and
a determination unit configured to determine harmony between the quality specification and the environment specification by adjusting, on the quality function deployment matrix and the environment specification matrix, a value of a property item of at least one of the quality specification and the environment specification.

8. The apparatus according to claim 7, wherein the output unit comprises a display which displays the property item of the other of the quality specification matrix and the environment specification matrix with respect to the specification item that appears in both the quality specification and the environment specification.

9. The apparatus according to claim 7, wherein the output unit comprises a display which displays a temporary target specification automatically to support compromise between a first target specification and a second target specification, when the first target specification and the second target specification include an identical property item or a property item having a correlation, the first target specification indicating a target specification of a quality aspect of a product included in the quality specification and the second target specification indicating a target specification of an environmental aspect included in the environment specification.

10. The apparatus according to claim 7, which further comprises a solution offering unit configured to offer a solution to conquer inconsistency when the quality specification and the environment specification include contradictory corrective strategies.

11. The apparatus according to claim 7, which the output unit comprises a display which displays importance information of parts provided from the quality function deployment matrix and influence information of a degree of influence of worth degradation of the parts, the influence information representing an influence that the worth degradation of the parts exerts to a product disposal action of a consumer.

12. The apparatus according to claim 7, which the output unit comprises a display which displays importance information of parts provided from the quality function deployment and one of useful life information of the parts and reliability information of the parts.

13. A program used for supporting a product life cycle planning and stored in a computer readable storage medium, comprising:
drawing instruction means for instructing a computer to draw up a quality function deployment matrix and an environment specification matrix according to a quality specification and an environment specification;
output instruction means for instructing the computer to output one of the quality function deployment matrix and the environment specification matrix and a specification item of the other of the quality function deployment matrix and the environment specification matrix; and
determination instruction means for instructing the computer to determine harmony between the quality specification and the environment specification by adjusting, on the quality function deployment matrix and the environment specification matrix, a value of a property item of at least one of the quality specification and the environment specification.

14. The program according to claim 13, wherein the output instruction means comprises instruction means for instructing the computer to display the property item of the other of the quality specification matrix and the environment specification matrix with respect to the specification item that appears in both the quality specification and the environment specification.

15. The program according to claim 13, wherein the output instruction means comprises instruction means for instructing the computer to display a temporary target specification automatically to support compromise between a first target specification and a second target specification, when the first target specification and the second target specification include an identical property item or a property item having a correlation, the first target specification indicating a target specification of a quality aspect of a product included in the quality specification and the second target specification indicating a target specification of an environmental aspect included in the environment specification.

16. The program according to claim 13, which further comprises offer instruction means for instructing the computer to offer a solution to conquer inconsistency when the quality specification and the environment specification include contradictory corrective strategies.

17. The program according to claim 13, which the output instruction means comprises instruction for instructing the computer to display importance information of parts provided from the quality function deployment matrix and influence information of a degree of influence of worth degradation of the parts, the influence information representing an affect that the worth degradation of the parts exerts to a product disposal action of a consumer.

18. The program according to claim 13, which the output instruction means comprises instruction means for instructing the computer to display importance information of parts provided from the quality function deployment and one of useful life information of the parts and reliability information of the parts.
